(19) United States
(12) Patent Application Publication
(10) Pub. No.: US 2025/0044213 A1
(43) Pub. Date: Feb. 6, 2025

(54) SINGLE-CELL DENSITY AS A BIOMARKER FOR DRUG SENSITIVITY

(71) Applicants: Massachusetts Institute of Technology, Cambridge, MA (US); Dana-Farber Cancer Institute, Inc., Boston, MA (US)

(72) Inventors: Scott R. Manalis, Cambridge, MA (US); Keith Ligon, Brookline, MA (US); Weida Wu, Medford, MA (US); Teemu Petteri Miettinen, Cambridge, MA (US); Sarah Ishamuddin, St. Louis, MO (US); Kin-Hoe Chow, Brookline, MA (US)

(73) Assignees: Massachusetts Institute of Technology, Cambridge, MA (US); Dana-Farber Cancer Institute, Inc., Boston, MA (US)

(21) Appl. No.: 18/715,057

(22) PCT Filed: Dec. 1, 2022
(86) PCT No.: PCT/US2022/051514

§ 371 Date: May 30, 2024

Related U.S. Application Data
(60) Provisional application No. 63/285,181, filed on Dec. 2, 2021.

(51) Int. Cl. G01N 15/14; G01N 9/24; G01N 15/10

(52) U.S. Cl. CPC G01N 15/1484; G01N 9/24; G01N 2015/1006

(57) ABSTRACT

Systems and methods for determining a density of a particle suspected of having been exposed to a therapeutic agent are generally described.

### RELATED APPLICATIONS

This application claims priority under 35 U.S.C. § 119 (e) to U.S. Provisional Patent Application No. 63/285,181, filed Dec. 2, 2021, and entitled “SINGLE-CELL DENSITY AS A BIOMARKER FOR DRUG SENSITIVITY,” which is incorporated herein by reference in its entirety for all purposes.

### TECHNICAL FIELD

Systems and methods for determining a density of a particle suspected of having been exposed to a therapeutic agent are generally described.

### BACKGROUND

The density of a cell is seldom measured because existing approaches for measuring the density of a cell with meaningful precision is both low throughput (e.g., a few hundred cells per afternoon) and complex. Accordingly, improved systems and methods are desired.

### SUMMARY

Systems and methods for determining a density of a particle suspected of having been exposed to a therapeutic agent are generally described. The subject matter of the present disclosure involves, in some cases, interrelated products, alternative solutions to a particular problem, and/or a plurality of different uses of one or more systems and/or articles.

In one aspect, a method for determining density of a particle suspected of having been exposed to a therapeutic agent is described, the method comprising flowing the particle through a microfluidic channel configured to receive the particle, the particle comprising a biomarker; driving the microfluidic channel with an excitation element; sensing a resonance frequency of the microfluidic channel as the particle flows through the microfluidic channel; exposing the particle to electromagnetic radiation and detecting an electromagnetic radiation signal; and determining the density of the particle based, at least in part, upon the resonance frequency and electromagnetic radiation signal, wherein the biomarker is associated with the therapeutic agent.

In another aspect, a method for determining densities of a plurality of particles suspected of having been exposed to a therapeutic agent is described, the method comprising flowing a mixture of a first plurality of particles and a second plurality of particles through a microfluidic channel configured to receive the particle; driving the microfluidic channel with an excitation element; sensing a plurality of resonance frequencies of the microfluidic channel as each of the particles of the mixture flows through the microfluidic channel; exposing the mixture to electromagnetic radiation and detecting an electromagnetic radiation signal for each of the particles of the mixture; and determining the density of each of the particles of the mixture based upon at least a portion of the plurality of resonance frequencies, wherein a coefficient of variance of an average of the densities of the first plurality of particles or the second plurality of particles, but not both, is less than or equal to 1%.

In another aspect, a microfluidic system for determining a density of a particle suspected of having been exposed to a therapeutic agent is described, the system comprising a first microfluidic channel associated with an inlet; an excitation element for driving the first microfluidic channel; a second microfluidic channel in fluidic communication with the first microfluidic channel; a source of electromagnetic radiation associated with the second microfluidic channel; a sensor associated with the first microfluidic channel configured to sense a resonance frequency of the first microfluidic channel; a detector configured to detect an electromagnetic radiation signal and associated with the second microfluidic channel; and a processor for determining the density of a particle and/or the presence of a biomarker related to the therapeutic agent based upon the electromagnetic radiation signal and resonance frequency of the first microfluidic channel.

Other advantages and novel features of the present disclosure will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic illustration of a system for determining a property of a particle, the system comprising, at least, a microfluidic channel than can resonate and a source of electromagnetic radiation, according to some embodiments;

FIG. 2 shows the results of exposing a population of cells to DMSO and trametinib in order to compare the effects of exposure to a drug to non-exposure to the drug, according to one set of embodiments; and

FIG. 3 is a set of plots that show the enhanced detection limit obtained when using density vs. buoyant mass, according to one set of embodiments.

### DETAILED DESCRIPTION

Systems and methods for determining a density of a particle suspected of having been exposed to a therapeutic agent are described below. Advantageously, determining the density of a single cell may be, in some cases, a desirable biophysical property as compared to mass or volume. For example, as described herein, the coefficient of variation (CV) of determining density in accordance with the embodiments described herein is generally smaller than the CV of determining mass or volume. Without wishing to be bound by theory, cells tightly regulate their density throughout the cell cycle even while the mass and/or volume of the cell may undergo significant changes. Despite this advantage, cell density is seldom measured because the existing techniques for doing so lack precision and are both low throughput and complex.

The present disclosure describes systems and methods for determining the density of particle (e.g., a cell). In some embodiments, the systems and methods may determine if particle has been exposed to a therapeutic agent by determining the density of the particle. These systems and methods may include a microfluidic channel (e.g., a microfluidic channel of a suspended microchannel resonator) that the particle may flow through and a source of electromagnetic radiation that can emit electromagnetic radiation (e.g., light) at the particle. The particle may comprise or be associated with a therapeutic agent or a biomarker (e.g., density) related to the therapeutic agent. The presence (or absence) of the biomarker may facilitate sorting of the particle from particles that where the biomarker is absent (or present). The microfluidic channel may be or may comprise a suspended microchannel resonator (SMR), which can be used to determine the mass (e.g., the buoyant mass) of the particle, while the electromagnetic radiation can be used to determine the volume of the particle, and the density of the particle can then be determined from these two parameters. Advantageously, these systems and methods may determine the density of a cell in a straightforward manner with a relatively high throughput when compared to existing techniques. As another advantage, because the density of a cell is typically more closely regulated than the constituent mass and/or volume of the cell, the cell may respond to a therapeutic agent with more sensitivity when measuring the density of the cell compared to the response of cell when measuring the mass and/or volume of a cell (under otherwise substantially identical conditions). Thus, a population of cells (e.g., a mixture of cells) may be exposed to a therapeutic agent and cells expressing a particular response (e.g., a particular biomarker) can be distinguished from those not expressing the particular response (e.g., cells not expressing a particular biomarker) based, at least in part, on the density of the cells within the population of cells.

In some embodiments, the systems and methods may be used to determine the density of a plurality suspected of having been exposed to a therapeutic agent, such as one or more populations of cells. In some such embodiments, the density of the cells may provide other information about the cells (e.g., the biological condition of the cells, whether or not the cell has been exposed to a therapeutic agent), such that the cells can be sorted into different subpopulations based, at least in part, on the density of the cells. Advantageously, the systems and methods described herein can determine the density of a cell with high precision. For example, in some embodiments, the determined density has a resolution of 0.001 g/mL, which may be sufficient for resolving inherent biological variation of various cell types, which typically have a standard deviation in the range of 0.005 to 0.01 g/mL. Of course, it may also allow for the determination of the mass and/or the volume of each cell within a population of cells. And while many of the exemplary embodiments described herein describe the determination of cell density, it should be understood that the systems and methods described herein may also be suitable for determining other properties of particles (e.g., mass, volume).

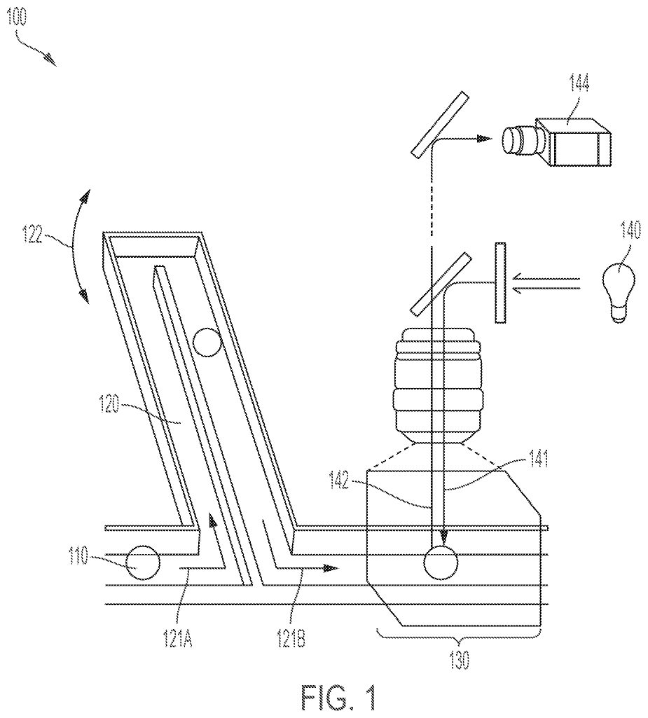

In some embodiments, the method includes flowing the particle through a microfluidic channel configured to receive the particle. For example, as illustrated schematically in FIG. 1, a system 100 comprises a particle 110 flowing within a microfluidic channel 120. Arrows 121A and 121B indicate the direction of flow of the particle (i.e., a fluid containing the particle). In some embodiments, the systems and methods include flowing a plurality of particles through a microfluidic channel configured to receive the particle. In some such embodiments, the system is configured to receive more than one particle (e.g., at least 2 particles, at least 10 particles, at least 10² particles, at least 10³ particles, at least 10⁴ particles, at least 10⁵ particles, at least 10⁶ particles, at least 10⁷ particles, at least 10⁸ particles) and the density (or some other property) of each particle (e.g., each cell) can be determined. In some embodiments, the method comprises flowing the particle through a microfluidic channel configured to receive the particle, the particle comprising a therapeutic agent and/or a biomarker. In some embodiments, the method comprises flowing the particle through a microfluidic channel configured to receive the particle, the particle comprising a biomarker. In some embodiments, the method comprises flowing a mixture of a first plurality of particles and a second plurality of particles through a microfluidic channel configured to receive the particle.

In some embodiments, the method includes driving the microfluidic channel with an excitation element. For example, in FIG. 1, a driving element (not pictured) provides resonation to the microfluidic channel 120, shown schematically as resonation 122. As described in more detail elsewhere herein, resonating the microfluidic channel may be used to determine the mass (e.g., the buoyant mass) of a particle within the microfluidic channel.

In some embodiments, the method includes sensing a resonance frequency of the microfluidic channel as the particle flows through the microfluidic channel. In some embodiments, the measured resonant frequency is related to the mass, such as a buoyant mass, of the particle). In some embodiments, the method includes sensing a plurality of resonance frequencies of the suspended microchannel resonator as each of the particles flows through the suspended microchannel resonator. In some embodiments, the method comprises sensing a plurality of resonance frequencies of the microfluidic channel as each of the particles of the mixture flows through the microfluidic channel.

In some embodiments, the method comprises exposing the particle to electromagnetic radiation and detecting an electromagnetic radiation signal. By way of illustration, FIG. 1 schematically depicts a light source 140 emitting light 141. In some embodiments, the particle may emit a signal 142, which can be detected by a detector 144. The signal detected by the detector may indicate a property of the particle, such as a particle volume. That is to say, in some embodiments, the signal is related to the volume of the particle. In some embodiments, the method comprises exposing the mixture (e.g., of a first plurality of particles and a second plurality of particles) to electromagnetic radiation and detecting an electromagnetic radiation signal for each of the particles of the mixture.

In some embodiments, the method includes determining the density of the particle based, at least in part, upon the resonance frequency and electromagnetic radiation signal. In some such embodiments, the resonance frequency may provide information about the mass of the particle and the electromagnetic radiation signal may provide information about the volume of particle, and this information can be used to determine the density of the particle. In some embodiments, the density of each particle of a plurality of particles is determined. In some embodiments, the density of at least some (but not necessarily all) of the particles of the plurality of particles is determined. In some embodiments, the density of a portion of a plurality of particles is determined. In some embodiments, an average density of the particles is determined. In some embodiments, the method comprises determining the density of the particle based, at least in part, upon the resonance frequency and electromagnetic radiation signal, wherein the biomarker is associated with the therapeutic agent. In some embodiments, the method comprises determining the density of each of the particles of a mixture of a first plurality of particles and a second plurality of particles based upon at least a portion of the plurality of resonance frequencies.

In some embodiments, a method for determining the density of a particle suspected of having been exposed to a therapeutic agent is described. For example, if the particle is a cell, upon exposure to a therapeutic agent, one or more properties of the cell may change (e.g., the buoyant mass, the volume, the density). In some such embodiments, the density of the particle may indicate exposure to the therapeutic agent. In some embodiments, the cell uptakes the therapeutic agent, and the therapeutic agent itself may act as a biomarker (e.g., the presence or absence of the therapeutic agent provides a biomarker). However, in other embodiments, the therapeutic may undergo one or more reactions (e.g., a chemical reaction, a biological reaction) within the particle (e.g., a cell) and/or outside the particle, such that the therapeutic agent is converted into another chemical species, which may act as a biomarker indicating that the particular particle has been exposed to the therapeutic agent. In some such embodiments, the density of particles that include the biomarker (e.g., a therapeutic agent or related to the therapeutic agent) relative to the density of particles that do not include the particles may be used to distinguish the particles. In some embodiments, a coefficient of variance of an average of the densities of the first plurality of particles or the second plurality of particles, but not both, is less than or equal to 1%. In such an embodiment, the difference in the coefficient of variance may be used to sort the first plurality of particles from the second plurality of particles. In some embodiments, the density of one or more particles (e.g., one or more cells) may be determined prior to exposure to the therapeutic agent. In some such embodiments, the density of the one or more particles prior to exposure to the therapeutic agent may be compared to the density of the one or more particles after exposure to the therapeutic agent. Advantageously, comparing the density of the one or more particles before and after exposure to the therapeutic agent may facilitate sorting of the particles.

As noted above, the systems and methods described herein may be useful for determining whether a particle (e.g., a cell) has been exposed to a therapeutic agent and/or whether it has a particular biomarker. Without wishing to be bound by theory, the density (e.g., the mass and volume) of a particle may be directly related to exposure to a particular therapeutic agent and/or the existence of a particular biomarker. In some cases, the density of the particle may be different prior to versus after exposure to the agent. In some embodiments, the distribution of densities of a plurality of particles (e.g., standard deviation relative to the mean) of the particle may be different prior to versus after exposure to the therapeutic agent. By way of example, in some embodiments, the standard deviation relative to the mean of the densities of a plurality of particles may be greater prior to exposure to a therapeutic agent as compared to after exposure to the therapeutic agent. In some embodiments, the standard deviation relative to the mean of the densities of a plurality of particles may be less prior to exposure to an agent as compared to after exposure to the agent. In some embodiments, the density of the particle may be correlated to a disease state (or lack thereof) of the particle.

The microfluidic systems described herein can be used for determining a density of a particle (or a plurality of particles). In some embodiments, other properties of a particle (e.g., mass, volume) may also be determined. In some embodiments, the particle is a single cell. In some embodiments, the density of each cell of a plurality of cells is determined. In some such embodiments, each cell of the plurality of cells may be sorted based, at least in part, on the determining the density. In some embodiments, a coefficient of variance of an average of the densities of the plurality of particles (e.g., sorted particles, unsorted particles) is less than or equal to 1% (e.g., less than or equal to 0.5%, less than or equal to 0.1%, less than or equal to 0.05%, less than or equal to 0.01%). In some embodiments, the coefficient of variation of the average of the densities of the plurality of particles is greater than or equal to 0.001%, greater than or equal to 0.005%, greater than or equal to 0.01%, greater than or equal to 0.05%, greater than or equal to 0.1%, or greater than or equal to 0.5%. Combinations of the above-referenced ranges are also possible (e.g., less than or equal to 1% and greater than or equal to 0.001%). Other ranges are also possible. The coefficient of variation, as used herein, is given its ordinary meaning in the art and generally refers to a ratio of a sample standard deviation to a sample mean.

The particle may be any particle suitable to flow within the microfluidic channel. In some embodiments, the particle is a biological entity. Non-limiting examples of biological entities include virions, bacteria, protein complexes, exosomes, cells, or fungi (e.g., yeast). In some embodiments, the biological entity includes, but is not limited to, sub-cellular components, such as organelles (e.g., ribosomes, mitochondria, nuclei). In some embodiments, the biological entity is obtained from a subject. A “subject” refers to any animal such as a mammal (e.g., a human). Non-limiting examples of subjects include a human, a non-human primate, a cow, a horse, a pig, a sheep, a goat, a dog, a cat, or a rodent such as a mouse, a rat, a hamster, a bird, a fish, or a guinea pig. In an exemplary embodiment, the biological entity is a human cell. In some embodiments, the biological entity comprises a plant (e.g., algae, moss, ferns, shrubs, cactus, aloe, daffodils) and/or a plant-derived biological species such as plant cells. In some embodiments, the systems and methods described herein are useful for separating biological entities into a microfluidic channel from a plurality of biological entities obtained from a subject (e.g., a population of cells from a human), for example, determining one or more physical properties of the biological entity (e.g., density), sorting, and/or diagnostic purposes.

The systems and methods described herein may be particularly useful for measuring physical properties (e.g., mechanical properties such as stiffness and/or Young's elastic modulus, a cross-linking density, a transport rate of small molecules into/out of the particle) of single particles such as individual cells (e.g., bacteria, yeast, liquid tumor cells, solid tumor cells suspended in fluid, immune cells). As mentioned above, such systems and methods may also be useful for measuring physical properties of a plurality of cells (e.g., exposure to a therapeutic agent, lack of exposure to a therapeutic agent).

In some embodiments, the particle (e.g., a single particle, a plurality of particles) is provided in a fluid. As used herein, a “fluid” is given its ordinary meaning, i.e., a liquid or a gas. A fluid cannot maintain a defined shape and will flow during an observable time frame to fill a container or channel in which it is put. Thus, the fluid may have any suitable viscosity that permits flow. In some embodiments, the particles are in disordered arrangement in the fluid. In some embodiments, the fluid is a liquid. In some embodiments, the fluid comprises water, a reagent, a solvent, a buffer, a cell-growth medium, or combinations thereof. In some embodiments, the particles are relatively soluble in the fluid.

Fluids can be introduced (e.g., transported, flowed, displaced) into the system (or a microfluidic channel therein) using any suitable component, for example, a pump, syringe, pressurized vessel, or any other source of pressure. Alternatively, fluids can be pulled into a microfluidic channel by the application of vacuum or reduced pressure on a downstream position (e.g., a vacuum port) of the system. Vacuum may be provided by any source capable of providing a lower pressure condition than exists upstream of a microfluidic channel of a system. Such sources may include vacuum pumps, aspirators, syringes, and evacuated containers. It should be understood, however, that in certain embodiments, methods described herein can be performed without a pressure drop across a microfluidic channel by using capillary flow, the use of valves, or other external controls that can vary pressure and/or flow rate of a microfluidic channel.

In some embodiments, a single particle (e.g., single cell) may be separated from a plurality of particles (e.g., a population of cells). In some embodiments, the amount of the particles used to separate a single particle from the plurality of particles. In some embodiments, the amount of particles in a fluid (e.g., a fluid flowing through a microfluidic channel) is greater than or equal to 100 particles per mL, greater than or equal to 250 particles per mL, greater than or equal to 500 particles per mL, greater than or equal to 1,000 particles per mL, greater than or equal to 2,500 particles per mL, or greater than or equal to 5,000 particles per mL of fluid. Advantageously, a single particle may be separated from a plurality of particles (e.g., plurality of biological entities) having a relatively large amount of particles per unit volume, using the method and systems described herein. For example, in some embodiments, the amount of particles in the fluid is greater than or equal to 10,000 particles per mL, greater than or equal to 25,000 particles per mL, greater than or equal to 50,000 particles per mL, greater than or equal to 100,000 particles per mL, greater than or equal to 150,000 particles per mL, greater than or equal to 200,000 particles per mL, greater than or equal to 250,000 particles per mL, greater than or equal to 300,000 particles per mL, greater than or equal to 350,000 particles per mL, greater than or equal to 400,000 particles per mL, greater than or equal to 450,000 particles per mL, greater than or equal to 500,000 particles per mL, greater than or equal to 550,000 particles per mL, greater than or equal to 600,000 particles per mL, greater than or equal to 650,000 particles per mL, greater than or equal to 700,000 particles per mL, greater than or equal to 750,000 particles per mL, greater than or equal to 800,000 particles per mL, greater than or equal to 850,000 particles per mL, greater than or equal to 900,000 particles per mL, or greater than or equal to 950,000 particles per mL of fluid. In some embodiments, the amount of particles in the fluid is less than or equal to 1,000,000 particles per mL, less than or equal to 950,000 particles per mL, less than or equal to 900,000 particles per mL, less than or equal to 850,000 particles per mL, less than or equal to 800,000 particles per mL, less than or equal to 750,000 particles per mL, less than or equal to 700,000 particles per mL, less than or equal to 650,000 particles per mL, less than or equal to 600,000 particles per mL, less than or equal to 550,000 particles per mL, less than or equal to 500,000 particles per mL, less than or equal to 450,000 particles per mL, less than or equal to 400,000 particles per mL, less than or equal to 350,000 particles per mL, less than or equal to 300,000 particles per mL, less than or equal to 250,000 particles per mL, less than or equal to 200.000 particles per mL, less than or equal to 150,000 particles per mL, less than or equal to 100,000 particles per mL, less than or equal to 50,000 particles per mL, or less than or equal to 25,000 particles per mL of fluid. In some embodiments, the amount of particles in the fluid is less than or equal to 7,500 particles per mL, less than or equal to 5,000 particles per mL, less than or equal to 2,500 particles per mL, less than or equal to 1,000 particles per mL, less than or equal to 500 particles per mL, or less than or equal to 250 particles per mL. Combinations of the above-referenced ranges are also possible (e.g., greater than or equal to 100 particles per mL and less than or equal to 10,000 particles per mL, greater than or equal to 100 particles per mL and less than or equal to 1,000,000 particles per mL, greater than or equal to 10,000 particles per mL and less than or equal to 1,000,000 particles per mL, greater than or equal to 10,000 particles per mL and less than or equal to 750,000 particles per mL, greater than or equal to 500,000 particles per mL and less than or equal to 750,000 particles per mL). Other ranges are also possible.

In some embodiments, a property of a particle (e.g., a single particle) in a plurality of particles may be determined at a variety of rates. In some embodiments, a property of a particle in a plurality of particles is determined at a rate of greater than or equal to 500 particles per hour, greater than or equal to 750 particles per hour, greater than or equal to 1000 particles per hour, greater than or equal to 1500 particles per hour, greater than or equal to 2000 particles per hour, greater than or equal to 2500 particles per hour, greater than or equal to 3000 particles per hour, greater than or equal to 4000 particles per hour, greater than or equal to 5000 particles per hour, or greater than or equal to 7500 particles per hour. In some embodiments, the property of the plurality of particles is determined at a rate of less than or equal to 7500 particles per hour, less than 5000 particles per hour, less than or equal to 4000 particles per hour, less than or equal to 3000 particles per hour, less than or equal to 2500 particles per hour, less than or equal to 2000 particles per hour, less than or equal to 1500 particles per hour, less than or equal to 1000 particles per hour, less than or equal to 750 particles per hour, or less than or equal to 500 particles per hour. Combinations of the above-referenced ranges are also possible (e.g., greater than or equal to 750 particles per hour and less than or equal to 7500 particles per hour). Other ranges are possible.

In an exemplary embodiment, the fluid comprises a plurality of cells, and the amount of cells within the fluid is greater than or equal to 10,000 particles per mL and less than or equal to 750,000 particles per mL. Advantageously, the systems and methods described herein may enable the loading of separated particle(s) into a channel at a particular frequency (e.g., less than or equal to 1 particle per 10 seconds) and/or spacing (e.g., greater than or equal to 1 mm) irrespective of the amount of particles in the fluid, as compared to passive loading of cells into channels. That is to say, in some embodiments, substantially the same method and/or system may be used to separate particles at a particular frequency and/or spacing within a microfluidic channel, without diluting (or concentrating) the particles in the fluid prior to loading the particle-containing fluid into the system. In some embodiments, a relatively high amount of particles in the fluid are in a disordered arrangement.

In some embodiments, the system (e.g., the microfluidic system) comprises one or more microfluidic channels. “Microfluidic channels” generally refer to channels having an average cross-sectional dimension of less than or equal to 1 mm. The one or more microfluidic channel can be any suitable channel, conduit, passage, or the like, and those skilled in the art in view of this disclosure will be capable of selecting appropriate channel. In some instances, the channel may be associated with (e.g., in fluidic communication with) an inlet and/or an outlet, in addition to one or more other channels. In some embodiments, the microfluidic channel is or includes a suspended microchannel resonator (SMR), which may be configured to resonate (e.g., during or after being driven by a driving element). In some embodiments, the microfluidic system comprises a first microfluidic channel associated with an inlet. In some embodiments, the microfluidic system comprises a second microfluidic channel in fluidic communication with the first microfluidic channel. In some embodiments, a plurality of microfluidic channels is present in a system and may be operated in tandem, such that the system may determine the property of several particles (or more) in tandem, each using a microfluidic channel to determine the property.

The microfluidic channels (e.g., a first microfluidic channel, a second microfluidic channel) of the system may have a particular average cross-sectional dimension. The “cross-sectional dimension” (e.g., a width, a height, a radius) of the channel is measured perpendicular to the direction of fluid flow. In some embodiments, the average cross-sectional dimension of a microfluidic channel is less than or equal to 1 mm, less than or equal to 800 μm, less than or equal to 600 μm, less than or equal to 500 μm, less than or equal to 400 μm, less than or equal to 300 μm, less than or equal to 200 μm, less than or equal to 100 μm, less than or equal to 50 μm, less than or equal to 25 μm, less than or equal to 20 μm, less than or equal to 15 μm, or less than or equal to 10 μm. In some embodiments, the average cross-sectional dimension of a microfluidic channel is greater than or equal to 5 μm, greater than or equal to 10 μm, greater than or equal to 15 μm, greater than or equal to 20 μm, greater than or equal to 25 μm, greater than or equal to 50 μm, greater than or equal to 100 μm, greater than or equal to 200 μm, greater than or equal to 300 μm, greater than or equal to 400 μm, greater than or equal to 500 μm, greater than or equal to 600 μm, or greater than or equal to 800 μm. Combinations of the above-referenced ranges are also possible (e.g., greater than or equal to 5 μm and less than or equal to 1 mm). Other ranges are also possible.

In some embodiments, a microfluidic channel of the system (e.g., the first microfluidic channel, the second microfluidic channel) may have any suitable cross-sectional shape (e.g., circular, oval, triangular, irregular, trapezoidal, square or rectangular, serpentine, u-shaped, or the like). A microfluidic channel may also have an aspect ratio (length to average cross-sectional dimension) of at least 2:1, more typically at least 3:1, 5:1, or 10:1 or more. A fluid within the microfluidic channel may partially or completely fill the fluidic channel.

In some embodiments, particles flow in the microfluidic channel at a particular average velocity along the longitudinal axis of the microfluidic channel. In some embodiments, the average velocity of particles along the longitudinal axis of the microfluidic channel is greater than or equal to 0.05 mm/second, greater than or equal to 0.1 mm/second, greater than or equal to 0.25 mm/second, greater than or equal to 0.5 mm/second, greater than or equal to 0.75 mm/second, greater than or equal to 1 mm/second, greater than or equal to 2 mm/second, greater than or equal to 3 mm/second, greater than or equal to 4 mm/second, greater than or equal to 5 mm/second, greater than or equal to 6 mm/second, greater than or equal to 7 mm/second, greater than or equal to 8 mm/second, greater than or equal to 9 mm/second, greater than or equal to 10 mm/second, greater than or equal to 20 mm/second, greater than or equal to 30 mm/second, greater than or equal to 40 mm/second, greater than or equal to 50 mm/second, greater than or equal to 60 mm/second, greater than or equal to 70 mm/second, greater than or equal to 80 mm/second, or greater than or equal to 90 mm/second. In some embodiments, the average velocity of particles along the longitudinal axis of a microfluidic channel is less than or equal to 100 mm/second, less than or equal to 90 mm/second, less than or equal to 80 mm/second, less than or equal to 70 mm/second, less than or equal to 60 mm/second, less than or equal to 50 mm/second, less than or equal to 40 mm/second, less than or equal to 30 mm/second, less than or equal to 20 mm/second, less than or equal to 10 mm/second, less than or equal to 9 mm/second, less than or equal to 8 mm/second, less than or equal to 7 mm/second, less than or equal to 6 mm/second, less than or equal to 5 mm/second, less than or equal to 4 mm/second, less than or equal to 3 mm/second, less than or equal to 2 mm/second, less than or equal to 1 mm/second, less than or equal to 0.75 mm/second, less than or equal to 0.5 mm/second, or less than or equal to 0.25 mm/second. Combinations of the above-referenced ranges are also possible (e.g., greater than or equal to 0.05 mm/second and less than or equal to 100 mm/second). Other ranges are also possible.

In some embodiments, a microfluidic channel (e.g., a first microfluidic channel, a second microfluidic channel) may have a particular configuration. In some embodiments, at least a portion of the microfluidic channel may be substantially linear in the direction of fluid flow. In some embodiments, at least a portion of the microfluidic channel may be curved, bent, serpentine, staggered, zigzag, spiral, or combinations thereof. Advantageously, the use of a non-linear fluidic channels may permit the incorporation of two or more microfluidic channels into the system (e.g., such that a plurality of particles may be measured in parallel, such that a change in a property of a single particle may be determined, e.g., in a plurality of microfluidic channels, either series or in parallel or some combination of both).

The systems and methods described herein may also include an excitation element. The excitation element may drive or cause resonation in a microfluidic channel (e.g., a first microfluidic channel). In some embodiments, the system comprises one or more components for oscillating a microfluidic channel and/or measuring the oscillation (and/or resonant frequency) of the microfluidic channels. For example, in some embodiments, the system comprises an actuator configured to vibrate (e.g., oscillate) the microfluidic channel (e.g., at a particular frequency and/or bending mode). While many of the embodiments described herein generally refer to a ‘microfluidic channel’, those of ordinary skill in the art would understand based upon the teachings of this specification that, in some embodiments, the microfluidic channel may be a channel of a suspended microchannel resonator.

A source of electromagnetic radiation may also be present within the system. In some embodiments, the source of electromagnetic associated with a microfluidic channel (e.g., a second microfluidic channel). In some embodiments, the source of electromagnetic radiation may provide light to a particle (e.g., a single cell, a plurality of cells). In some such embodiments, the provided light my trigger a luminescence event (e.g., fluorescence) within or associated with the particle, which may act as a signal. In some such embodiments, the signal may provide information (e.g., data) about the volume of the particle. In some embodiments, the electromagnetic radiation signal is a luminescence signal within the particle. In some embodiments, the electromagnetic radiation signal comprises a difference between electromagnetic radiation detected in the presence of the particle and electromagnetic radiation detected in the absence of the particle under substantially identical conditions.

In some embodiments, the volume of a particle (e.g., a cell) may be determined, for example, by weighing the particle in the suspended microchannel using two fluids with different densities. In some embodiments, the node deviation is normalized by a median volume (e.g., a median volume of a plurality of particles of the same type). Suitable methods for determining the volume of a single particle (or plurality of particles) are generally described in commonly-owned U.S. Pat. No. 8,087,284, entitled “Method And Apparatus For Measuring Particle Characteristics Through Mass Detection”, issued Jan. 3, 2012, which is incorporated herein by reference in its entirety for all purposes.

In some embodiments, a sensor is associated with a microfluidic channel (e.g., a first microfluidic channel, a suspended microchannel resonator). In sensor may be configured to sense a resonance frequency of the suspended microchannel resonator.

In some embodiments, the system may also comprise a detector to detect electromagnetic radiation from the particle (e.g., a signal from the particle). In some embodiments, the detector configured to detect an electromagnetic radiation signal and associated with the second microfluidic channel.

In some embodiments, the system also comprises a processor for determining the density of a particle based upon the electromagnetic radiation signal and resonance frequency of the microfluidic channel. In some such embodiments, the processor is a controller and/or microprocessor. In certain of embodiments, the controller is configured (e.g., programmed) to receive and transmit data commands to/from one or more components of the system (e.g., the driving element, a sensor and/or detector). In some such embodiments, the data includes one or more signals from one or more detectors. In some such embodiments the controller and/or microprocessor is configured to determine the resonant frequency of a microfluidic channel (e.g., a suspended microchannel). In such some embodiments, the controller may be configured to adjust various parameters based on external metrics. For example, in certain embodiments, the controller is configured to adjust the oscillation frequency of a microfluidic channel in response to a signal from a user and/or a detector in electrical communication with the controller. In some such embodiments, the controller adjusts the oscillation frequency in response to a signal from the detector due to a particle in the microfluidic channel.

In some embodiments, a processor and/or a controller may include one or more proportional, integral (PI), and/or derivative (PID) feedforward and/or feedback loops to adjust the oscillation frequency of a microfluidic channel. The controller may be implemented by any suitable type of analog and/or digital circuitry. In one set of embodiments, the processor and/or the controller may be implemented in a field programmable gate array (FPGA). For example, the processor and/or the controller may be implemented using hardware or a combination of hardware and software. When implemented using software, suitable software code can be executed on any suitable processor (e.g., a microprocessor, FPGA) or collection of processors. The processor and/or the controller can be implemented in numerous ways, such as with dedicated hardware, or with general purpose hardware (e.g., one or more processors) that is programmed using microcode or software to perform the functions recited above.

In this respect, it should be appreciated that one implementation of the embodiments described herein comprises at least one computer-readable storage medium (e.g., RAM, ROM, EEPROM, flash memory or other memory technology, or other tangible, non-transitory computer-readable storage medium) encoded with a computer program (i.e., a plurality of executable instructions) that, when executed on one or more processors, performs the above discussed functions of one or more embodiments. In addition, it should be appreciated that the reference to a computer program which, when executed, performs any of the above-discussed functions, is not limited to an application program running on a host computer. Rather, the terms computer program and software are used herein in a generic sense to reference any type of computer code (e.g., application software, firmware, microcode, or any other form of computer instruction) that can be employed to program one or more processors to implement aspects of the techniques discussed herein.

The article(s), system(s), and device(s) or portions thereof (e.g., a microfluidic channel, a suspended microchannel resonator) described herein can be fabricated of any suitable material. Non-limiting examples of materials include polymers (e.g., polypropylene, polyethylene, polystyrene, poly(acrylonitrile, butadiene, styrene), poly(styrene-co-acrylate), poly(methyl methacrylate), polycarbonate, polyester, poly(dimethylsiloxane), PVC, PTFE, PET, or blends of two or more such polymers), adhesives, and/or metals including nickel, copper, stainless steel, bulk metallic glass, or other metals or alloys, or ceramics including glass, quartz, silica, alumina, zirconia, tungsten carbide, silicon carbide, or non-metallic materials such as graphite, silicon, or others.

As mentioned above, the systems and methods described herein may be useful for distinguishing particles that are suspected of having been exposed to a drug or therapeutic agent. The therapeutic agent may be one or a combination of therapeutic, diagnostic, and/or enhancement agents, such as drugs, nutrients, microorganisms, in vivo sensors, and tracers. In some embodiments, the therapeutic agent comprises a perturbagen (i.e., a substance, such a natural or synthetic peptide, capable of and/or configured to disrupt an intracellular process). In an exemplary embodiment, the therapeutic agent is trametinib. In some embodiments, the therapeutic agent is a nutraceutical, prophylactic, or diagnostic agent. While much of the specification describes the use of therapeutic agents, other agents listed herein are also possible. Agents can include, but are not limited to, any synthetic or naturally-occurring biologically active compound or composition of matter which, when administered to a subject (e.g., a human or nonhuman animal), induces a desired pharmacologic, immunogenic, and/or physiologic effect by local and/or systemic action, such as changing the density of a cell. For example, useful or potentially useful within the context of certain embodiments are compounds or chemicals traditionally regarded as drugs, vaccines, and biopharmaceuticals. Certain such agents may include molecules such as proteins, peptides, hormones, nucleic acids, gene constructs, etc., for use in therapeutic, diagnostic, and/or enhancement areas, including, but not limited to medical or veterinary treatment, prevention, diagnosis, and/or mitigation of disease or illness (e.g., HMG-COA reductase inhibitors (statins) like rosuvastatin, nonsteroidal anti-inflammatory drugs like meloxicam, selective serotonin reuptake inhibitors like escitalopram, blood thinning agents like clopidogrel, steroids like prednisone, antipsychotics like aripiprazole and risperidone, analgesics like buprenorphine, antagonists like naloxone, montelukast, and memantine, cardiac glycosides like digoxin, alpha blockers like tamsulosin, cholesterol absorption inhibitors like ezetimibe, metabolites like colchicine, antihistamines like loratadine and cetirizine, opioids like loperamide, proton-pump inhibitors like omeprazole, anti (retro) viral agents like entecavir, dolutegravir, rilpivirine, and cabotegravir, antibiotics like doxycycline, ciprofloxacin, and azithromycin, anti-malarial agents, and synthroid/levothyroxine); substance abuse treatment (e.g., methadone and varenicline); family planning (e.g., hormonal contraception); performance enhancement (e.g., stimulants like caffeine); and nutrition and supplements (e.g., protein, folic acid, calcium, iodine, iron, zinc, thiamine, niacin, vitamin C, vitamin D, and other vitamin or mineral supplements).

In some embodiments, the therapeutic agent is one or more specific therapeutic agents. As used herein, the term “therapeutic agent” (or also referred to as a “drug”) refers to an agent that is administered to a subject to treat a disease, disorder, or other clinically recognized condition, or for prophylactic purposes, and has a clinically significant effect on the body of the subject to treat and/or prevent the disease, disorder, or condition. Listings of examples of known therapeutic agents can be found, for example, in the United States Pharmacopeia (USP), Goodman and Gilman's The Pharmacological Basis of Therapeutics, 10th Ed., McGraw Hill, 2001; Katzung, B. (ed.) Basic and Clinical Pharmacology, McGraw-Hill/Appleton & Lange; 8th edition (Sep. 21, 2000); Physician's Desk Reference (Thomson Publishing), and/or The Merck Manual of Diagnosis and Therapy, 17th ed. (1999), or the 18th ed (2006) following its publication, Mark H. Beers and Robert Berkow (eds.), Merck Publishing Group, or, in the case of animals, The Merck Veterinary Manual, 9th ed., Kahn, C. A. (ed.), Merck Publishing Group, 2005; and “Approved Drug Products with Therapeutic Equivalence and Evaluations,” published by the United States Food and Drug Administration (F.D.A.) (the “Orange Book”). Examples of drugs approved for human use are listed by the FDA under 21 C.F.R. §§ 330.5, 331 through 361, and 440 through 460, incorporated herein by reference; drugs for veterinary use are listed by the FDA under 21 C.F.R. §§ 500 through 589, incorporated herein by reference. In certain embodiments, the therapeutic agent is a small molecule. Exemplary classes of therapeutic agents include, but are not limited to, analgesics, anti-analgesics, anti-inflammatory drugs, antipyretics, antidepressants, antiepileptics, antipsychotic agents, neuroprotective agents, anti-proliferatives, such as anti-cancer agents, antihistamines, antimigraine drugs, hormones, prostaglandins, antimicrobials (including antibiotics, antifungals, antivirals, antiparasitics), antimuscarinics, anxioltyics, bacteriostatics, immunosuppressant agents, sedatives, hypnotics, antipsychotics, bronchodilators, anti-asthma drugs, cardiovascular drugs, anesthetics, anti-coagulants, inhibitors of an enzyme, steroidal agents, steroidal or non-steroidal anti-inflammatory agents, corticosteroids, dopaminergics, electrolytes, gastro-intestinal drugs, muscle relaxants, nutritional agents, vitamins, parasympathomimetics, stimulants, anorectics and anti-narcoleptics. Nutraceuticals can also be incorporated into the drug delivery device. These may be vitamins, supplements such as calcium or biotin, or natural ingredients such as plant extracts or phytohormones.

In another embodiment, the therapeutic agent is an immunosuppressive agent. Exemplary immunosuppressive agents include glucocorticoids, cytostatics (such as alkylating agents, antimetabolites, and cytotoxic antibodies), antibodies (such as those directed against T-cell receptors or Il-2 receptors), drugs acting on immunophilins (such as cyclosporine, tacrolimus, and sirolimus) and other drugs (such as interferons, opioids, TNF binding proteins, mycophenolate, and other small molecules such as fingolimod). In certain embodiments, the therapeutic agent is a hormone or derivative thereof. Non-limiting examples of hormones include insulin, growth hormone (e.g., human growth hormone), vasopressin, melatonin, thyroxine, thyrotropin-releasing hormone, glycoprotein hormones (e.g., luteinzing hormone, follicle-stimulating hormone, thyroid-stimulating hormone), eicosanoids, estrogen, progestin, testosterone, estradiol, cortisol, adrenaline, and other steroids.

In some embodiments the therapeutic agent may be a virus, bacteria, or antibody drug conjugate (ADC). In some embodiments, the therapeutic agent is an antigen, such as an antigen from or derived from a coronavirus (e.g., SARS-COV-2).

In some embodiments, the therapeutic agent is a small molecule drug having molecular weight less than about 2500 Daltons, less than about 2000 Daltons, less than about 1500 Daltons, less than about 1000 Daltons, less than about 750 Daltons, less than about 500 Daltons, less or than about 400 Daltons. In some cases, the therapeutic agent is a small molecule drug having molecular weight between 200 Daltons and 400 Daltons, between 400 Daltons and 1000 Daltons, or between 500 Daltons and 2500 Daltons.

In some embodiments, the therapeutic agent is selected from the group consisting of active pharmaceutical agents such as probiotics, polysaccharides, compounds derived from fecal matter, glycans, antigen mimics, CAS nucleases, nucleic acids, peptides, proteins, bacteriophage, modified bacteria, DNA, mRNA, human growth hormone, monoclonal antibodies, adalimumab, epinephrine, GLP-1 Receptor agoinists, semaglutide, liraglutide, dulaglitide, exenatide, factor VIII, small molecule drugs, progrstin, vaccines, subunit vaccines, recombinant vaccines, polysaccharide vaccines, and conjugate vaccines, toxoid vaccines, influenza vaccine, shingles vaccine, prevnar pneumonia vaccine, MMR vaccine, tetanus vaccine, hepatitis vaccine, HIV vaccine Ad4 env Clade C, HIV vaccine Ad4-mGag, DNA vaccines, RNA vaccines, etanercept, infliximab, filgastrim, glatiramer acetate, rituximab, bevacizumab, any molecule encapsulated in a nanoparticle, epinephrine, lysozyme, glucose-6-phosphate dehydrogenase, other enzymes, certolizumab pegol, ustekinumab, ixckizumab, golimumab, brodalumab, guselkumab, secikinumab, omalizumab, TNF-alpha inhibitors, interleukin inhibitors, vedolizumab, octreotide, teriperatide, CRISPR-Cas9, antisense oligonucleotides, and ondansetron. In certain embodiments, the therapeutic agent may comprise a polyunsaturated fatty acid (e.g. butyric acid, propionic acid), an omega-3 fatty acid (e.g., docosahexaenoic acid, cicosapentaenoic acid), a bismuth salt e.g. (bismuth subgallate), or a polysaccharide.

In some embodiments, the wt % of the therapeutic agent relative to the weight of a particle is greater than or equal to 1%, greater than or equal to 5%, greater than or equal to 10 wt %, greater than or equal to 15 wt %, greater than or equal to 20 wt %, greater than or equal to 25 wt %, greater than or equal to 30 wt %, greater than or equal 40 wt %, greater than or equal to 50 wt %, greater than or equal to 60 wt %, greater than or equal to 70 wt %, greater than or equal to 75 wt %, greater than or equal to 80 wt %, greater than or equal 90 wt %, or greater than or equal to 95 wt %. In some embodiments, the wt % of therapeutic agent relative to the weight of a particle is less than or equal to 95 wt %, less than or equal to 90 wt %, less than or equal to 80 wt %, less than or equal to 75 wt %, less than or equal to 70 wt %, less than or equal to 60 wt %, less than or equal to 50 wt %, less than or equal to 40 wt %, less than or equal to 30 wt %, less than or equal to 25 wt %, less than or equal to 20 wt %, less than or equal to 15 wt %, less than or equal to 10 wt %, less than or equal to 5 wt %, or less than or equal to 1 wt %. Combinations of the above-references ranges are also possible (e.g., greater than or equal to 1 wt % and less than or equal to 50 wt %). Other ranges are possible.

The following applications are incorporated herein by reference, in their entirety, for all purposes: U.S. Publication No. US 2018/0299362, published on Oct. 18, 2018, filed as U.S. application Ser. No. 15/940,001 on Mar. 29, 2018, and entitled “SYSTEMS, ARTICLES, AND METHODS FOR FLOWING PARTICLES”; U.S. Publication No. US 2018/0245972, published on Aug. 30, 2018, filed as International Patent Application No. PCT/US2015/057634 on Oct. 27, 2015, and entitled “SIMULTANEOUS OSCILLATION AND FREQUENCY TRACKING OF MULTIPLE RESONANCES VIA DIGITALLY IMPLEMENTED PHASE-LOCKED LOOP ARRAY”; and U.S. Publication No. US 2021/0046477, published on Feb. 18, 2021, filed as U.S. application Ser. No. 16/901,924 on Jun. 15, 2020, and entitled “RAPID AND HIGH-PRECISION SIZING OF SINGLE PARTICLES USING PARALLEL SUSPENDED MICROCHANNEL RESONATOR ARRAYS AND DECONVOLUTION”.

The following examples are intended to illustrate certain embodiments of the present invention, but do not exemplify the full scope of the invention.

### Example 1

The following example describes separating a mixture of cells based on the presence of a biomarker as determined by the changing density of the cells.

The Inventors have discovered and recognized that single-cell density shows the promise to be superior to buoyant mass as a biomarker for drug response. Without wishing to be bound by any particular theory, the reason is that single-cell density has the potential to be a superior biomarker is that its coefficient of variation (CV) for cell density is more than 10-fold smaller than that of buoyant mass. It is believed that this is because cells tightly regulate their density throughout the cell cycle even while mass and volume independently may undergo significant changes. However, when a cell is perturbed (e.g. exposure to a drug), density is altered in way that is more statistically significant than mass or volume. However, certain existing systems and methods for determining the density of cell are largely inadequate because of their low throughput and complexity in setting up. However, the system and methods described in this example allow for the density of cells to be determined in a straightforward manner with relatively high throughput when compared to certain existing systems and methods. In some cases, a density resolution of 0.001 g/mL may be achieved, which is sufficient for resolving the inherent biological variation of various cell types (which typically has a standard deviation in the range of 0.005 to 0.01 g/mL). Additionally, it enables mass, density, and volume to be measured from each cell.

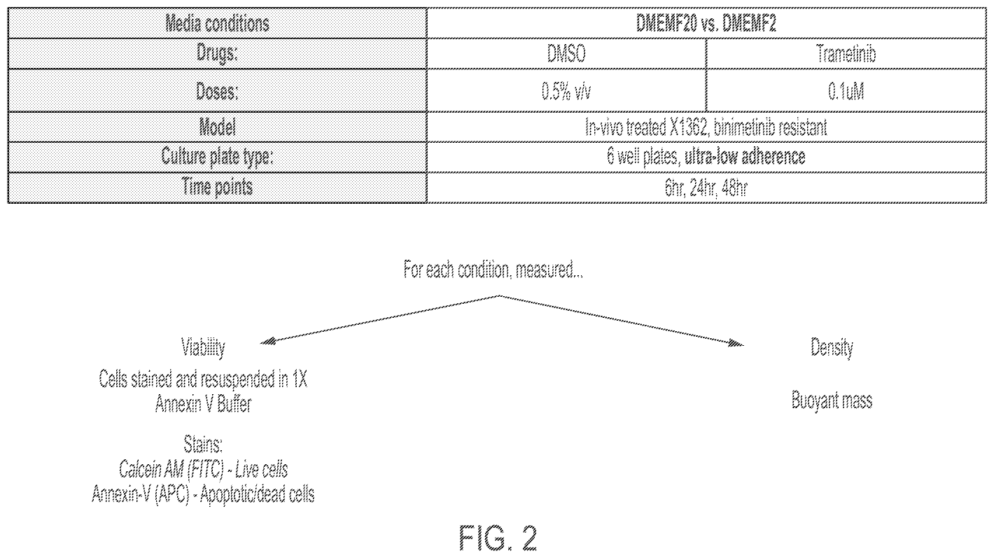

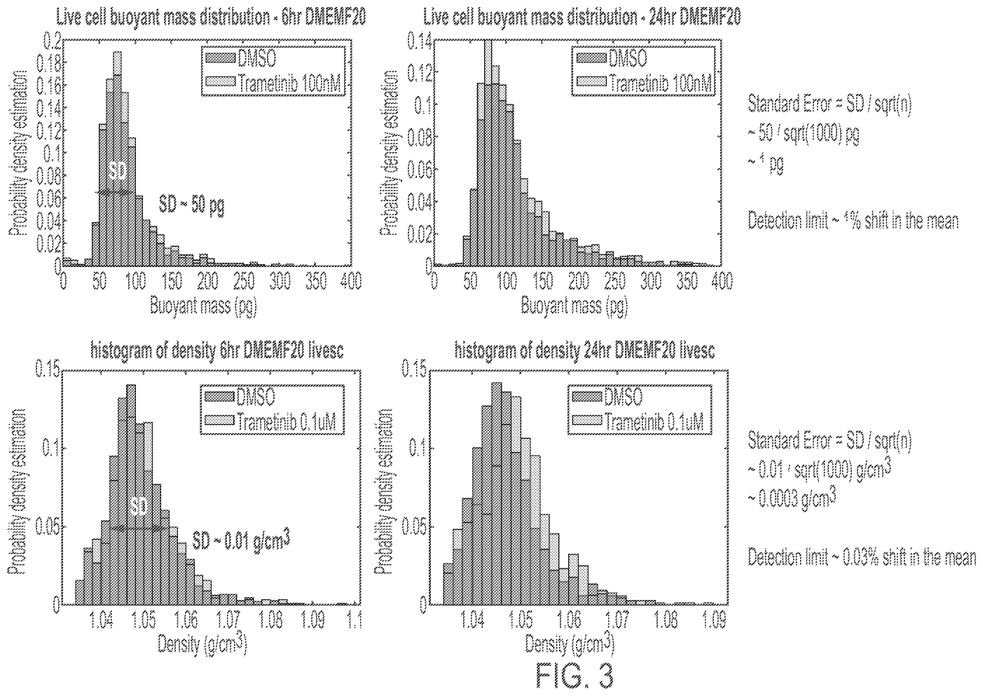

The systems and methods of this example have been used in the PDX (patient-derived xenograft) outlined in FIG. 2. Even though this PDX model is known to be sensitive to trametinib, acute drug sensitivity with viability markers and buoyant mass showed no statistically significant response when compared to control. However, density did show a clear response, as shown in FIG. 3. The rationale in favor of the superiority of density over buoyant mass is shown by the estimates on the right of the figure. That is, because the CV for buoyant mass is so large, the mean must shift by several percentages in order to resolve a drug response. In contrast, the CV for density is over an order of magnitude smaller, allowing a shift of ˜0.1% to registered (approximately 3× the detection limit of ˜0.03%).

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of.” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of.” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method for determining density of a particle suspected of having been exposed to a therapeutic agent, the method comprising:
flowing the particle through a microfluidic channel configured to receive the particle, the particle comprising a biomarker;
driving the microfluidic channel with an excitation element;
sensing a resonance frequency of the microfluidic channel as the particle flows through the microfluidic channel;
exposing the particle to electromagnetic radiation and detecting an electromagnetic radiation signal; and
determining the density of the particle based, at least in part, upon the resonance frequency and the electromagnetic radiation signal,
wherein the biomarker is associated with the therapeutic agent.

2. A method for determining densities of a plurality of particles suspected of having been exposed to a therapeutic agent, the method comprising:
flowing a mixture of a first plurality of particles and a second plurality of particles through a microfluidic channel configured to receive the particle;
driving the microfluidic channel with an excitation element;
sensing a plurality of resonance frequencies of the microfluidic channel as each of the particles of the mixture flows through the microfluidic channel;
exposing the mixture to electromagnetic radiation and detecting an electromagnetic radiation signal for each of the particles of the mixture; and
determining the density of each of the particles of the mixture based upon at least a portion of the plurality of resonance frequencies,
wherein a coefficient of variance of an average of the densities of the first plurality of particles or the second plurality of particles, but not both, is less than or equal to 1%.

3. The method of any one of the preceding claims, wherein the first plurality of particles and/or the second plurality of particles comprise a biomarker associated with the therapeutic agent.

4. The method of any one of the preceding claims, further comprising sorting the mixture into the first plurality of particles and the second plurality of particles based on the step of determining the density of each of the particles.

5. The method of any one of the preceding claims, wherein the electromagnetic radiation signal comprises a difference between electromagnetic radiation detected in the presence of the particle and electromagnetic radiation detected in the absence of the particle under substantially identical conditions.

6. The method of any one of the preceding claims, further comprising sorting the particle based, at least in part, on the determining the density.

7. The method of any one of the preceding claims, wherein an average velocity of particles is greater than or equal to 0.05 mm/second and/or less than or equal to 100 mm/second.

8. A microfluidic system for determining a density of a particle suspected of having been exposed to a therapeutic agent, comprising:
a first microfluidic channel associated with an inlet;
an excitation element for driving the first microfluidic channel;
a second microfluidic channel in fluidic communication with the first microfluidic channel;
a source of electromagnetic radiation associated with the second microfluidic channel;
a sensor associated with the first microfluidic channel configured to sense a resonance frequency of the first microfluidic channel;
a detector configured to detect an electromagnetic radiation signal and associated with the second microfluidic channel; and
a processor for determining the density of a particle and/or the presence of a biomarker related to the therapeutic agent based upon the electromagnetic radiation signal and resonance frequency of the first microfluidic channel.

9. The system or method of any one of the preceding claims, wherein the particle is a single cell.

10. The system or method of any one of the preceding claims, wherein the electromagnetic radiation is light.

11. The system or method of any one of the preceding claims, wherein the density is resolved within at least 0.001 g/mL.

12. The system or method of any one of the preceding claims, wherein the first microfluidic channel has a cross-sectional dimension of greater than or equal to 10 μm and/or less than or equal to 1 mm.

13. A system or method of any one of the preceding claims, wherein the particle is suspended in a fluid.

14. The system or method of any one of the preceding claims, wherein the first microfluidic channel has a throughput of greater than or equal to 6,800 particles/min and less than or equal to 100,000 particles/min.
